(19) United States
(12) Patent Application Publication
(10) Pub. No.: US 2020/0094712 A1
(43) Pub. Date: Mar. 26, 2020

(54) Strap Retaining Device

(71) Applicant: Teodoro Rico, N Miami Beach, FL (US)

(72) Inventor: Teodoro Rico, N Miami Beach, FL (US)

(21) Appl. No.: 16/140,674

(22) Filed: Sep. 25, 2018

(51) Int. Cl. B60N 2/28; F16B 2/24

(52) U.S. Cl. CPC B60N 2/2812; B60N 2002/2815; F16B 2/241

(57) ABSTRACT

A strap retaining device for facilitating positioning of a child in a safety seat includes a pair of panels. Each panel is arcuately shaped proximate to a first end of the panel to define a hook section of the panel. Each of a pair of couplers is coupled to a respective panel proximate to a second end of the respective panel. The coupler is configured to couple the respective panel to a respective opposing side of a child safety seat so that the hook section is positioned proximate to a front of the child safety seat. The hook section is configured to insert into a loop that is defined by an associated strap of the child safety seat to removably couple the associated strap to the hook section. The hook section retains the associated strap in an open configuration to facilitate positioning of a child in the child safety seat.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relate to retaining devices and more particularly pertains to a new retaining device for facilitating positioning of a child in a safety seat.

### (h) BRIEF SUMMARY OF THE INVENTION

An embodiment of the disclosure meets the needs presented above by generally comprising a pair of panels. Each panel is arcuately shaped proximate to a first end of the panel to define a hook section of the panel. Each of a pair of couplers is coupled to a respective panel proximate to a second end of the respective panel. The coupler is configured to couple the respective panel to a respective opposing side of a child safety seat so that the hook section is positioned proximate to a front of the child safety seat. The hook section is configured to insert into a loop that is defined by an associated strap of the child safety seat to removably couple the associated strap to the hook section. The hook section retains the associated strap in an open configuration to facilitate positioning of a child in the child safety seat.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a strap retaining device according to an embodiment of the disclosure.

FIG. 2 is a front view of an embodiment of the disclosure.

FIG. 3 is a side view of an embodiment of the disclosure.

FIG. 4 is an end view of an embodiment of the disclosure.

FIG. 5 is an end view of an embodiment of the disclosure.

FIG. 6 is an in-use view of an embodiment of the disclosure.

### (j) DETAILED DESCRIPTION OF THE INVENTION

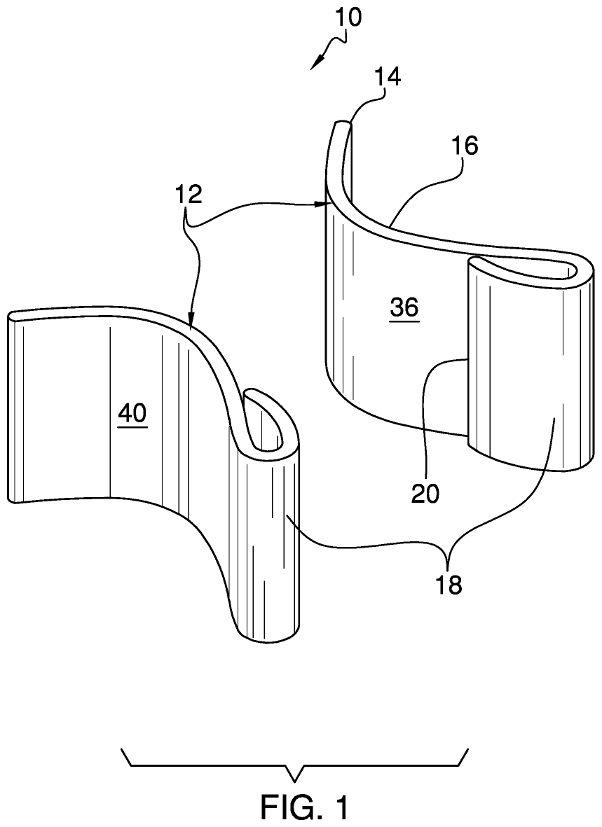

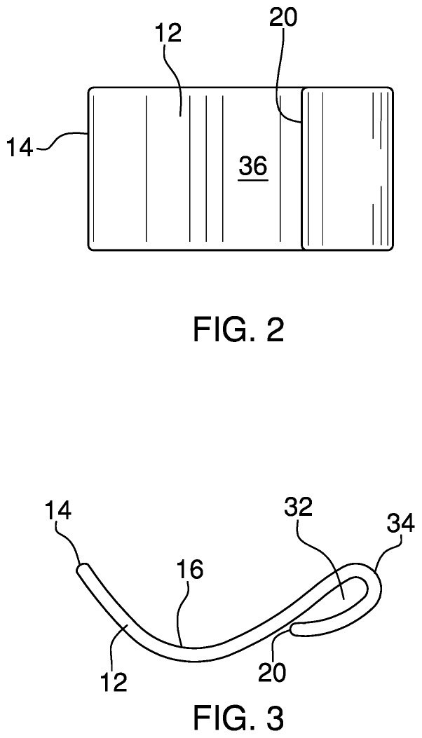

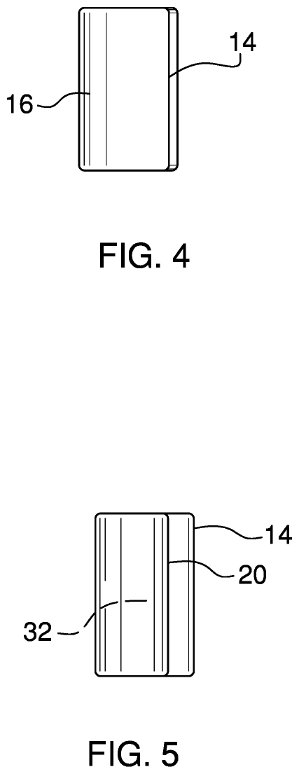

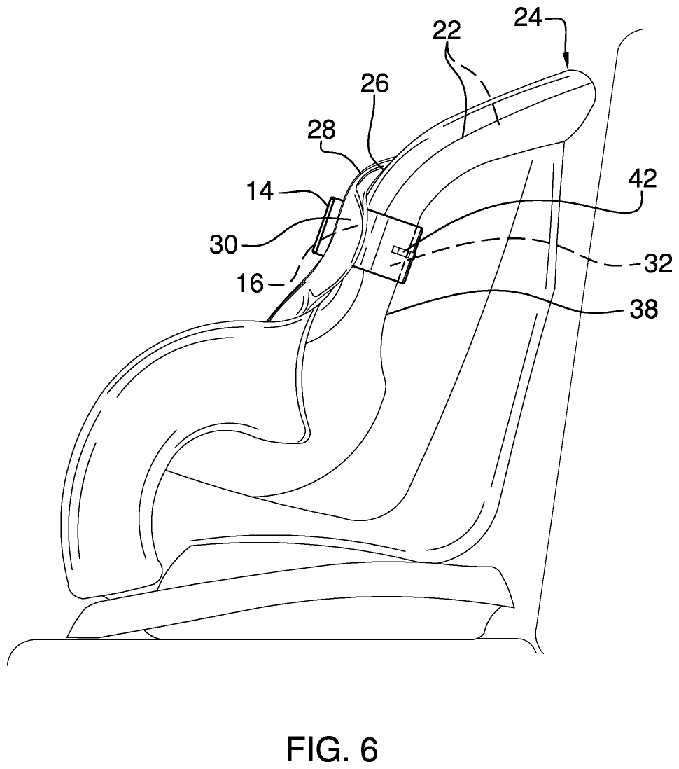

With reference now to the drawings, and in particular to FIGS. 1 through 6 thereof, a new retaining device embodying the principles and concepts of an embodiment of the disclosure and generally designated by the reference numeral 10 will be described.

As best illustrated in FIGS. 1 through 6, the strap retaining device 10 generally comprises a pair of panels 12. Each panel 12 is arcuately shaped proximate to a first end 14 of the panel 12 to define a hook section 16 of the panel 12, as shown in FIG. 3. The panels 12 comprise plastic or the like.

Each of a pair of couplers 18 is coupled to a respective panel 12 proximate to a second end 20 of the respective panel 12. The coupler 18 is configured to couple the respective panel 12 to a respective opposing side 22 of a child safety seat 24, as shown in FIG. 6, so that the hook section 16 is positioned proximate to a front 26 of the child safety seat 24. The hook section 16 is configured to be inserted into a loop 28 that is defined by an associated strap 30 of the child safety seat 24 to removably couple the associated strap 30 to the hook section 16. The associated strap 30 is retained in an open configuration to facilitate placement of a child into, and removal of the child from, the child safety seat 24.

The coupler 18 comprises a slot 32. The slot 32 is defined by a bend 34 that is positioned in the respective panel 12 proximate to the second end 20, as shown in FIG. 3. The second end 20 of the respective panel 12 is positioned proximate to an inner face 36 of the respective panel 12. The slot 32 is configured to insert a rear edge 38 of the respective opposing side 22 of the child safety seat 24 to frictionally couple the respective panel 12 to the respective opposing side 22 of the child safety seat 24 so that the hook section 16 is positioned proximate to the front 26 of the child safety seat 24. The hook section 16 is configured to insert into the loop 28 that is defined by the associated strap 30 of the child safety seat 24. The associated strap 30 is positioned on an outer face 40 of the respective panel 12 to removably couple the associated strap 30 to the hook section 16. The associated strap 30 is retained in the open configuration to facilitate the placement of the child into, and the removal of the child from, the child safety seat 24.

A clip 42 is selectively couplable to the panel 12 at the bend 34. The clip 42 is configured to enhance frictional coupling of the respective panel 12 to the respective opposing side 22 of the child safety seat 24. The clip 42 comprises metal.

In use, the rear edge 38 of the respective opposing side 22 of the child safety seat 24 is inserted into the slot 32 to frictionally couple the respective panel 12 to the respective opposing side 22 of the child safety seat 24. The loop 28 that is defined by the associated strap 30 of the child safety seat 24 is positioned over the hook section 16 to removably couple the associated strap 30 to the hook section 16. The associated strap 30 is retained in the open configuration to facilitate the placement of the child into, and the removal of the child from, the child safety seat 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. A strap retaining device comprising:
a pair of panels, each panel being arcuately shaped proximate to a first end of the panel defining a hook section of the panel, each of the panels being continuous and having parallel top and bottom edges; and
a pair of couplers, each coupler being integrally coupled to a respective panel proximate to a second end of the respective panel such that coupler and respective panel define a unitary piece wherein the coupler is configured for coupling the respective panel to a respective opposing side of a child safety seat such that the hook section is positioned proximate to a front of the child safety seat wherein the hook section is configured for inserting into a loop defined by an associated strap of the child safety seat for removably coupling the associated strap to the hook section for retaining the associated strap in an open configuration for placing a child into and removing the child from the child safety seat, each coupler comprising a slot, the slot being defined by a bend positioned in the respective panel proximate to the second end such that the second end is positioned proximate to an inner face of the respective panel wherein the slot is configured for inserting a rear edge of the respective opposing side of the child safety seat for frictionally coupling the respective panel to the respective opposing side of the child safety seat such that the hook section is positioned proximate to the front of the child safety seat extending laterally outward wherein the hook section is configured for inserting into the loop defined by the associated strap of the child safety seat positioning the associated strap on an outer face of the respective panel for removably coupling the associated strap to the hook section for retaining the associated strap in the open configuration for placing the child into and removing the child from the child safety seat.

2. The device of claim 1, further including the panels comprising plastic.

3. (canceled)

4. The device of claim 1, further including the bend being arcuate.

5. The device of claim 4, further including a clip selectively couplable to the panel at the bend wherein the clip is configured for enhancing frictional coupling of the respective panel to the respective opposing side of the child safety seat.

6. The device of claim 5, further including the clip comprising metal.

7. (canceled)

8. A strap retaining device comprising:
a pair of panels, each panel being arcuately shaped proximate to a first end of the panel defining a hook section of the panel, each of the panels being continuous and having parallel top and bottom edges, the panels comprising plastic;
a pair of couplers, each coupler being integrally coupled to a respective panel proximate to a second end of the respective panel such that coupler and respective panel define a unitary piece wherein the coupler is configured for coupling the respective panel to a respective opposing side of a child safety seat such that the hook section is positioned proximate to a front of the child safety seat wherein the hook section is configured for inserting into a loop defined by an associated strap of the child safety seat for removably coupling the associated strap to the hook section for retaining the associated strap in an open configuration for placing a child into and removing the child from the child safety seat, the coupler comprising a slot, the slot being defined by a bend positioned in the respective panel proximate to the second end such that the second end is positioned proximate to an inner face of the respective panel wherein the slot is configured for inserting a rear edge of the respective opposing side of the child safety seat for frictionally coupling the respective panel to the respective opposing side of the child safety seat such that the hook section is positioned proximate to the front of the child safety seat extending laterally outward wherein the hook section is configured for inserting into the loop defined by the associated strap of the child safety seat positioning the associated strap on an outer face of the respective panel for removably coupling the associated strap to the hook section for retaining the associated strap in the open configuration for placing the child into and removing the child from the child safety seat, the bend being arcuate; and
a clip selectively couplable to the panel at the bend wherein the clip is configured for enhancing frictional coupling of the respective panel to the respective opposing side of the child safety seat, the clip comprising metal.
